(19) United States
(12) Patent Application Publication
(10) Pub. No.: US 2007/0004461 A1
(43) Pub. Date: Jan. 4, 2007

(54) Terminal with messaging application

(76) Inventors: Sridhar N. Bathina, Los Altos Hills, CA (US); Vesa Luiro, Oulu (FI); Kimberly Sudderth, Trophy Club, TX (US); Colum M. Duffy, Tokyo (JP); Jens Benner, Copenhagen (DK)

Correspondence Address: PERMAN & GREEN, 425 POST ROAD, FAIRFIELD, CT, 06824, US

(21) Appl. No.: 11/172,436

(22) Filed: Jun. 30, 2005

(51) Int. Cl. H04M 1/00; H04B 1/38

(52) U.S. Cl. 455/566; 455/556.2

(57) ABSTRACT

A handheld portable communications terminal includes a freehand input device, such as a touch screen or a digital pen, and plural messaging applications. One messaging application allows a user to input a drawing using the freehand input device, and produces drawing data in a standard or commonly-used format representative of the drawing. A second messaging application, selected by the first messaging application, sends the drawing data in a message in a standard or commonly-used format (e.g. SMS, MMS, IM, email). This allows the drawing to be reproduced by a receiving terminal equipped with a standard or common messaging application. The first messaging application provides for the immediate entry of a drawing using a freehand input device in response to the opening of the messaging application. It provides means to allow a recipient address to be entered or selected in response to an input indicating the completion of content entry. It also allows the message to be sent through a single user input in response to the entry or selection of a recipient address.

### FIELD OF THE INVENTION

The invention relates to a handheld portable communications terminal comprising a freehand input device, and at least one messaging application. The invention relates also to a method of operating a handheld portable communications terminal, the terminal comprising: a freehand input device; and at least one messaging application. Further, the invention relates to a mobile terminal operable to allow a user to enter a drawing for sending through a messaging application, and also to a method of operating a mobile terminal to allow a user to enter a drawing for sending through a messaging application forming part of the terminal.

### BACKGROUND OF THE INVENTION

It is now relatively common for handheld electronic devices such as mobile or cellular telephones and personal digital assistants (PDAs) to be provided with touch screens, allowing input through the use of a stylus. The Nokia 7710™ is one example. A stylus is usually used for menu navigation and general selection, although they can be used as well for the input of text through a handwriting recognition application on the device. On the Nokia 7710™, the stylus can also be used for drawing images. The full potential allowed by including stylus input-on mobile devices has not so far been realised. Input devices having a similar effect include the Nokia SU-1B Digital Pen™.

US 2002/0159600 describes a system in which free-hand drawn SMS messages can be sent from a device with a pen input. Handwriting recognition is carried out using an intermediate smart card or at a server. OCR may be used. Free-hand drawings can be sent. However, the described system has limitations, in that network-side analysis and/or processing of message contents is necessary, in that the arrangement is such that many user inputs are required before a message can be sent, in that a recipient device needs an intermediate smart card in order to present received messages including free-hand drawn input to a user, and in that special hardware in the form of an intermediate smart card, is required to prepare such a message for sending.

### SUMMARY OF THE INVENTION

According to a first aspect of the invention, there is provided a handheld portable communications terminal comprising:
a freehand input device; and
at least one messaging application;
   the messaging application being operable to allow a user to input a drawing using the freehand input device, to produce drawing data in a standard or commonly-used format representative of the drawing, and to send a message in a standard or commonly-used format incorporating the drawing data, thereby allowing the drawing to be reproduced by a receiving terminal equipped with a standard or common messaging application.

The term ‘standard or commonly-used format’ will be understood to embrace within its scope each format which is defined by accepted standards defining a messaging protocol to be supported by messaging applications supporting that protocol, and commonly-used formats which are not specifically standardised. Thus, the message sent by a terminal will be able to reproduced properly by every messaging application which is arranged according to the recognised standards defining that messaging protocol, if it is standardised, or by the commonly used protocol on the other hand, thereby avoiding the need for recipients to have special software or hardware installed with their terminal. This can occur without any modification of the message by a server connected on a network through which the message is sent. The standard or commonly-used format may for example be SMS format, with the drawing being represented as a bitmap according to SMS standards. The standard or commonly-used format may instead be one which is able to be handled correctly by standard, off-the-shelf email applications, for instance.

The freehand input device may for instance include a touch screen, or an external input device, such as a digital pen, coupled to the terminal.

Preferably, the terminal includes first and second messaging applications, the first messaging application being operable to allow a user to input the drawing, and the second messaging application being operable to send the message. Here, the second messaging application may be one which would ordinarily be resident on a terminal, so the invention could be implemented merely by including the first messaging application on the terminal.

The first messaging application may be operable to select the second messaging application from a plurality of messaging applications included with the terminal. In this case, the first messaging application may be operable to select the second messaging application based at least in part on an address type of a recipient address to which the message is addressed, on a content of the message, on an expected cost of sending the message, on radio networks which are available to the terminal and/or on at least one pre-existing user preference. Regardless of how the second messaging application is selected, it may be provided to a user as a selectable default send option.

The second messaging application may be selected from the group: SMS application, MMS application, instant message application, and email application, although other messaging applications may be suitable.

According to a second aspect of the invention, there is provided a method of operating a handheld portable communications terminal, the terminal comprising: a freehand input device, and at least one messaging application, the method comprising:
allowing a user to input a drawing using the freehand input device,
producing drawing data, representative of the drawing, in a standard or commonly-used format, and
sending a message in a standard or commonly-used format incorporating the drawing data,
   thereby allowing the drawing to be reproduced by a receiving terminal equipped with a standard or common messaging application.

The invention also provides machine-readable instructions which when executed by computer apparatus control it to perform this method, and computer-readable media having stored thereon machine readable instructions which when executed by computer apparatus control it to perform this method.

According to a third aspect of the invention, there is provided a mobile terminal operable to allow a user to enter a drawing for sending through a messaging application, the messaging application being:
responsive to the opening of the messaging application to provide for the immediate entry of a drawing using a freehand input device;
responsive to an input indicating the completion of content entry to provide means to allow a recipient address to be entered or selected; and
responsive to the entry or selection of a recipient address to allow the message to be sent through a single user input.

The provision for the input of a drawing is immediate in the sense that no additional user input is required before the drawing can be entered. This terminal is advantageous since it allows a message comprising a drawing to be sent in as few as four user inputs (in addition to the drawing input), namely a first input to open the application, a second to indicate drawing entry completion, a third to select a recipient, and a fourth to select the sending of the message. This has advantages for the user, who is able to send a drawing with minimum hassle, and for the input transducers of the terminal, which experience less use, and thus reduced wear and greater reliability and lifespan, compared to the corresponding use of a less convenient messaging application.

The terminal may be arranged to display a dynamic menu in response to a user input. Use of a dynamic menu is advantageous since it allows a user to proceed through the steps needed to prepare and send the message with a small number of user inputs.

The dynamic menu may include as a default option an option which relates to an action in a pre-determined sequence which immediately follows an action which has most recently been completed by a user. This is particularly advantageous since it can allow a user to proceed through the steps needed to prepare and send the message with a minimum number of user inputs.

According to a third aspect of the invention, there is provided a method of operating a mobile terminal to allow a user to enter a drawing for sending through a messaging application forming part of the terminal, the method comprising:
in response to the opening of the messaging application, to providing for the immediate entry of a drawing using a freehand input device;
in response to an input indicating the completion of content entry, providing means to allow a recipient address to be entered or selected; and
in response to the entry or selection of a recipient address, allowing the message to be sent through a single user input.

The invention also provides machine-readable instructions which when executed by computer apparatus control it to perform this method, and also machine readable instructions which when executed by computer apparatus control it to perform this method.

Embodiments of the invention will now be described, by way of example only, with reference to the accompanying drawings.

### BRIEF DESCRIPTION OF THE DRAWINGS

In the drawings:

FIG. 1 is a view of a mobile terminal operable according to certain aspects of the invention and including a touch screen;

FIG. 2 is a view of a mobile terminal and digital pen combination operable according to certain aspects of the invention;

FIG. 3 is a schematic diagram illustrating software and hardware components of the FIGS. 1 and 2 mobile terminals;

FIG. 4 is a flowchart illustrating operation of a scribbler application operating according to several aspects of the invention; and

FIGS. 5A to 5H show screen shots of the FIG. 1 or FIG. 2 mobile terminal at various stages in the FIG. 4 flow chart.

### DETAILED DESCRIPTION OF THE PREFERRED EMBODIMENT

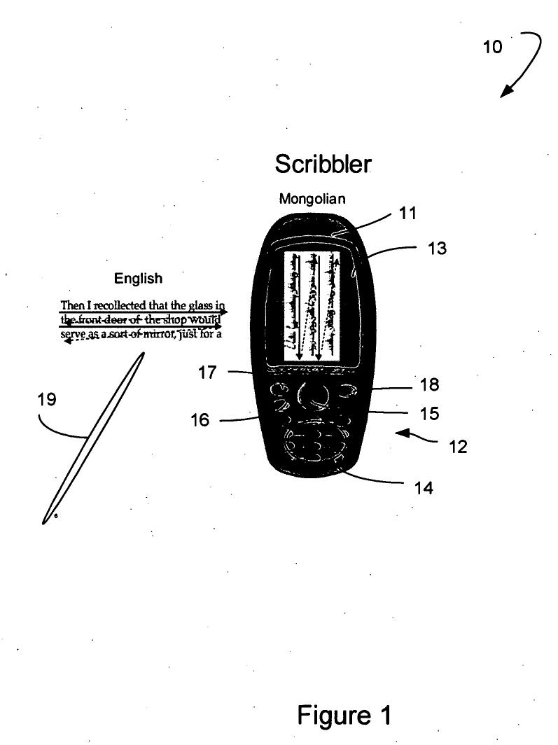

Referring to FIG. 1, a mobile terminal 10 is shown. This a mobile telephone including a housing 11, a keypad 12 and a touch screen 13. The keypad 12 includes a group 14 of alpha numeric keys, a four-way directional key with central selection 15, a function key 16 and left and right soft keys 17 and 18. The mobile phone 10 is also provided with a stylus 19, allowing a user to input information into the mobile phone 10 byway of the touch screen 13.

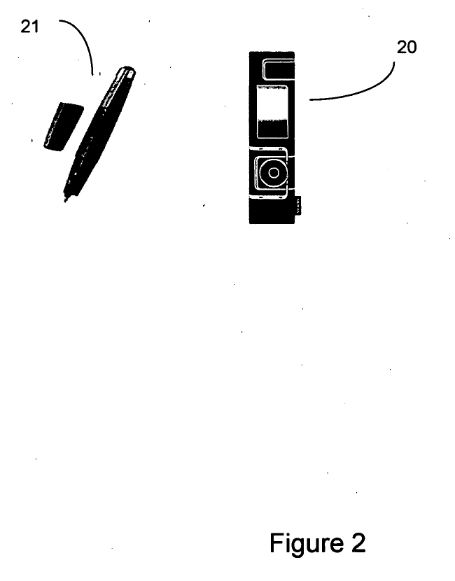

FIG. 2 illustrates an alternative mobile device 20. In this Figure, the mobile terminal 20 is a compact GSM mobile phone including a rotator user interface. The mobile phone may, for example, be the Nokia 7280™. The mobile phone 20 is wirelessly coupled to a digital pen 21. This may be for example the Digital Pen produced and sold under product no. SU-1B. This allows the user to make drawings inputs to the mobile phone 20 even though the phone does not have a touch screen or other touch pad.

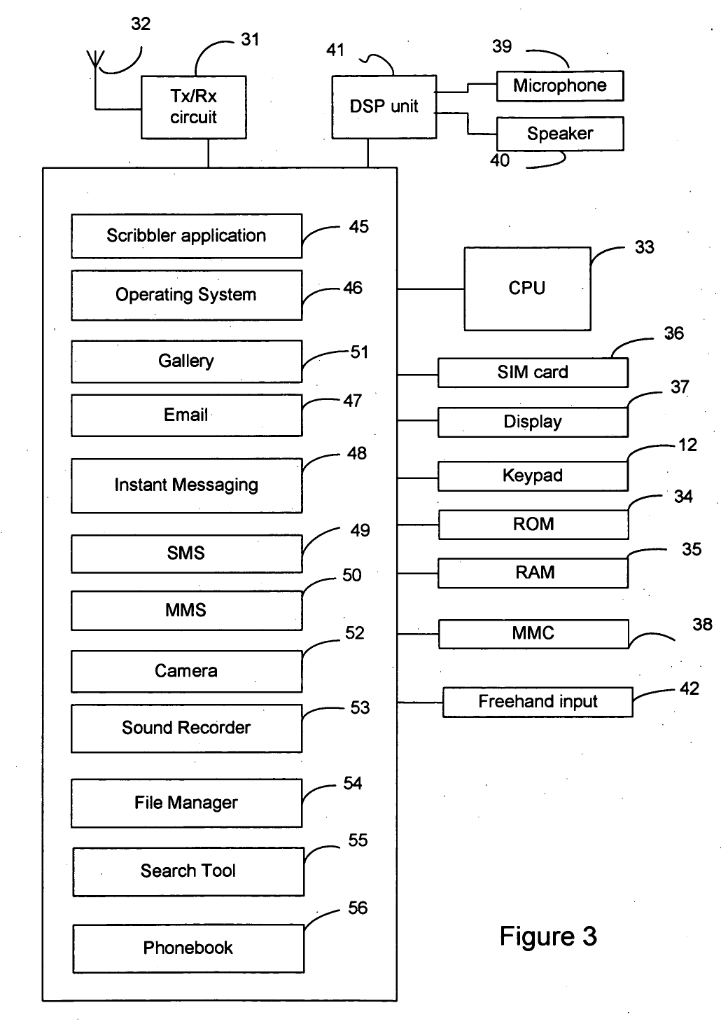

FIG. 3 shows hardware and software components of the FIG. 1 mobile phone 10 and of the FIG. 2 mobile phone 20. Only components directly relevant to the operation of the scribbler application are illustrated in FIG. 3. It will be appreciated that other components are present, but are omitted from the Figure for the sake of clarity.

The primary components of the mobile phone 30, which is either the mobile phone 10 and the mobile phone 20 of FIGS. 1 and 2 respectively, are a transmit and receive circuit 31, an antenna 32, a central processing unit (CPU) 33, read-only memory (ROM) 34 and random access memory (RAM) 35. Other hardware components include a subscriber identity module (SIM) card 36, a display 37 and a removable memory card or MMC 38. In the case of the mobile phone 10, the display 37 of FIG. 3 is the touch screen 13 of FIG. 1. The mobile phone 13 also includes a microphone 39 and a speaker 40, which are connected to the other components of the phone a digital signal processing (DSP) unit 41.

The mobile phone 30 also includes a freehand writing input 42. In the case of the mobile phone 10 of FIG. 1, this is the touch screen 13. In the case of the FIG. 2 mobile phone, this is the digital pen 21.

The phone 30 also includes a number of software applications, namely a scribbler application 45, an operating system 46 (for example the Symbian™ operating system). The mobile phone 30 also includes a number of messaging applications, namely an email application 47, an instant messaging (IM) application 48, a short message service (SMS) application 49 and a multimedia service (MMS) application 50. The mobile phone 30 also includes a media gallery application 51, a camera 52 and a sound recorder 53. The scribbler application 45 is a messaging application since it is involved in the entry and sending of messages. Except for the scribbler application 45, all of the hardware and software components of the mobile phone 13 may be conventional.

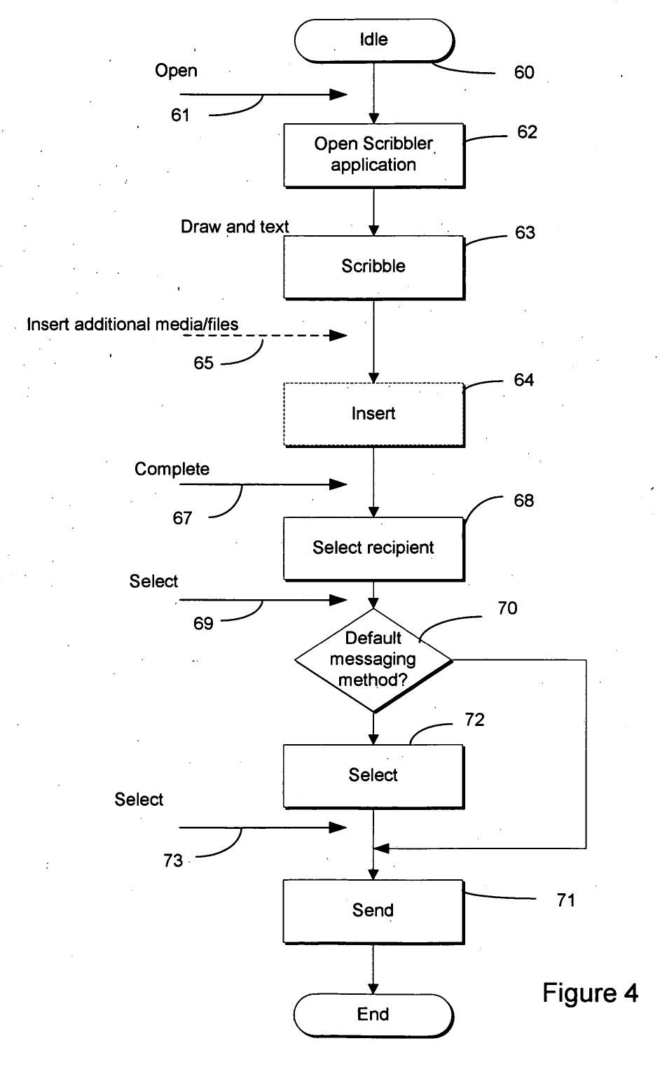

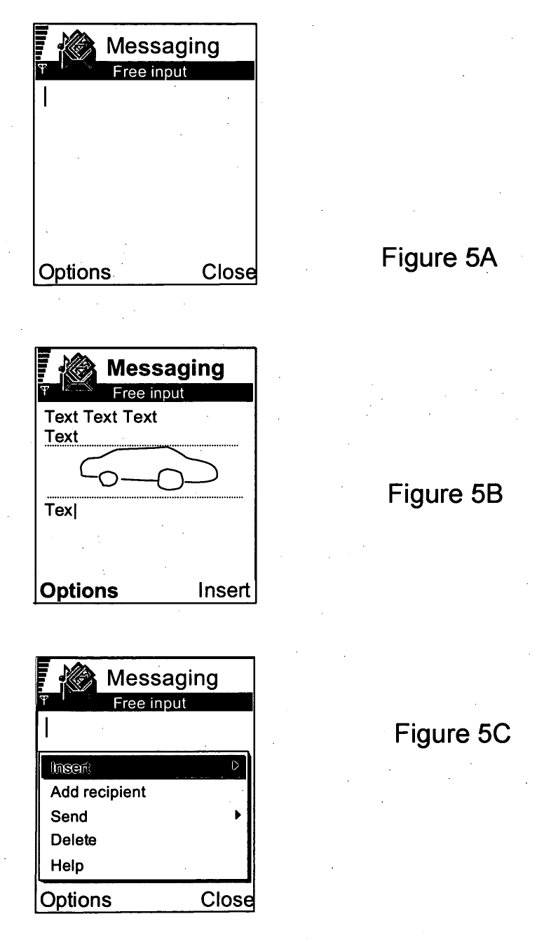

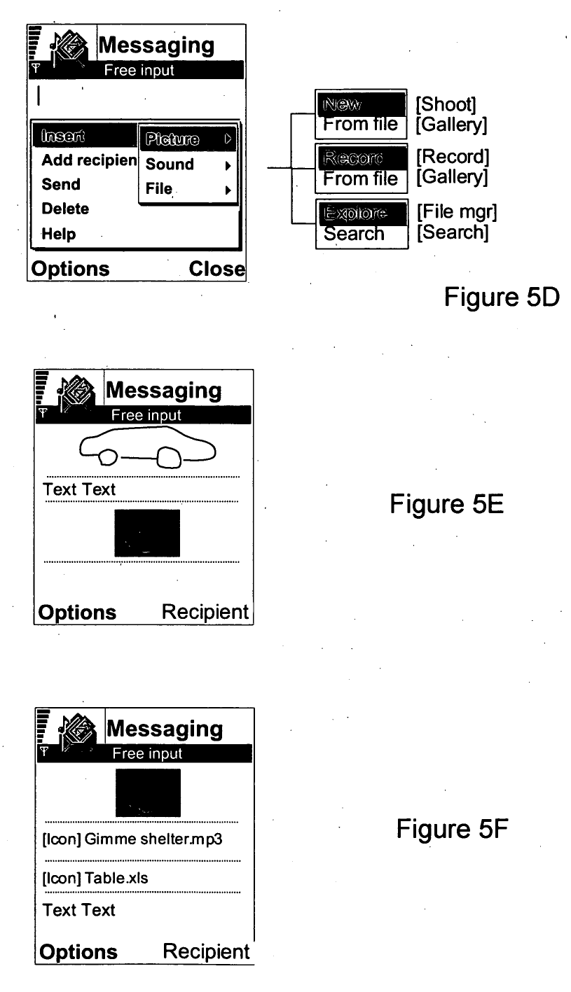

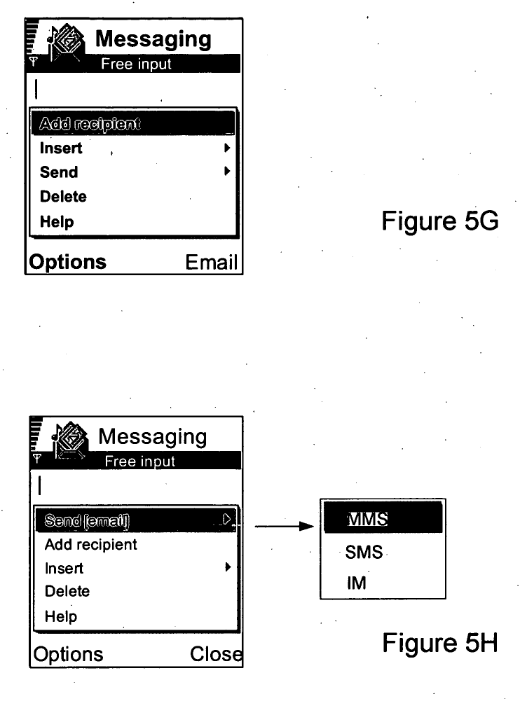

Operation of the mobile phone 30 when running the scribbler application 45 will now be described with reference to FIGS. 4 and 5A to 5H.

Referring to FIG. 4, operation beings in idle mode 60. Following a user input 61 to open the scribbler application 45, the scribbler application is opened at 62. Following step 62, the mobile phone 30 displays the screen shot shown in FIG. 5A. From FIG. 5A it can be seen that the word ‘Messaging’ is displayed in bold type at the top of the display, with the words ‘Free input’ in slightly smaller text. Immediately beneath that is a blank entry area At the bottom of the screen shot, it is indicated that the right soft key, shown as 18 in FIG. 1, has the function of closing the application, and the left soft key, shown as 17 in FIG. 1, has the function of providing a list of options.

Following step 62, the user may enter a drawing. This involves either application of the stylus 19 to the touch screen 13, or else operation of the digital pen 21. In either case, the mobile phone 30 is arranged so as to display the drawing on the display 37. The user has the option as well of entering text using the keypad 14, or using an optical character recognition (OCR) feature of the digital pen 21. As can be seen from the screen shot of FIG. 5B, the user has entered text then entered a drawing and then is in the process of entering further text beneath the drawing. The entering of text at step 63 is optional. If text is entered following the entering of a drawing, then a further drawing entered appears after the text as a default. At step 63, the left soft key 17 is indicated as leading to ‘Options’, and the right soft key 18 is indicated as selecting an ‘Insert’ function.

In this example, the user operates the left soft key 17, thereby selecting ‘Options’. Following depression of the left soft key 17, the display 37 is provided with the screen shot shown in FIG. 5C. Here, a dynamic menu is overlaid onto the existing display. The menu is dynamic since the option which is at the top of the menu and which is highlighted by default and is the option which relates to the next action in the sequence Insert-Add recipient-Send.

The option ‘Insert’ includes a small arrow at the right side of the display 37, which indicates to the user that there are further options associated with this option. FIG. 5D illustrates the options available. The screen shot of FIG. 5D illustrates the state of the display 37 following depression of a directional right key from the FIG. 5C screen shot. It can be seen that an additional submenu overlay is present. This submenu overlay includes ‘Picture’, ‘Sound’ and ‘File’ options, each of which includes a small arrow at the right side indicating that there are further options associated with it. These further options are illustrated to the right of the FIG. 5D screen shot. In particular, when the ‘Picture’ option is selected, a submenu is overlaid onto the display, giving ‘New’ as the default option and ‘From file’ also as an available option. If the user selects ‘New’, the camera application 52 is opened so that the user can take a photo. If the user selects the ‘From file’ option, the gallery application 51 is opened, allowing the user to browse for and select a photo preexisting on the mobile phone 30. If from the first submenu the user presses the right directional key when the ‘Sound’ option is highlighted, a further submenu is overlaid. This further submenu has a default option ‘Record’, and a secondary option ‘From file’. If the ‘Record’ option is selected, the sound recorder application 53 is opened so that the user can record a sound. If the ‘From file’ option is selected, the gallery application 51 is opened, allowing the user to select a pre-existing file from the gallery. If when the ‘File’ option is highlighted the user presses the right directional key, a further submenu is overlaid. This submenu gives ‘Explore’ as the default option and gives ‘Search’ as a secondary option. If the ‘Explore’ option is selected by the user, the file manager application 54 is opened, allowing the user to browse for a pre-existing file to attach. If instead the ‘Search’ option is selected, the search tool application 55 is opened, allowing the user to search for a preexisting file stored on the mobile phone 30.

FIG. 5E illustrates a screen shot of the display 37 following the inclusion in the message of a picture, either using the camera application 52 or using the gallery application 51. Since an additional media item has been inserted, the function of the right soft key 18 is changed by the scribbler application 45 to allow the user to specify that a recipient is to be added. However, it is possible at this stage to attach further media items. To add a further media item, the user merely presses the left soft key 17, which causes the scribbler application 45 to provide the submenu shown in FIG. 5C as an overlay onto the display 37. In this instance, the option ‘Insert’ is dynamically selected as the default option, since the ‘Add recipient’ option is easily selected from the screen shot of FIG. 5E by pressing the right soft key 18. Once the submenu is overlaid, the type of insert and the actual insert can be selected in the manner described above with reference to FIG. 5D.

Further media items can be added, and a sound file entitled ‘Gimme Shelter.mp3’ and a spreadsheet file entitled ‘Table.xls’ have been included in the message in the screen shot shown in FIG. 5F. The left soft key 17 is the trigger which allows the user to add a further media item. After a media item has been added, pressing the left soft key 17 results in the option submenu being overlaid on the display 37, and the right soft key 18 results in a recipient being allowed to be added or selected.

The insertion of media items and/or files is indicated at 64 in FIG. 4 as an optional step. In this case, the optional insertion step 64 is initiated by the pressing of the right soft key 18 when the display 37 is in the state indicated in FIG. 5B. This is indicated at 65 in FIG. 4.

However, this step is optional. It can be omitted altogether by arranging the scribbler application 45 such that the user can progress from entering a drawing to adding a recipient in a single key press or other user input. For example, the scribbler application 45 may be arranged such that depression of the central part of the directional key 15 or the other function key 16 of the mobile phone 30 results in the insertion step 64 being omitted. Such a depression of the central part of the navigation key 15 or the other function key 16 constitutes a content complete input, indicated at 67 in FIG. 4. If one or more media items have been included in the message, depression of the right soft key 18, highlighted ‘Recipient’, constitutes the complete input 67. Whatever the form of the complete input 67, it results in a display allowing the user to enter a recipient's address or select a recipient from the phonebook 56 or from a list of recently and/or commonly contacted recipients. This is not illustrated in the Figures.

If, instead, the user were to press the left soft key 17 from the screen shot shown in FIG. 5F, then the ‘Options’ submenu is overlaid on the display 37, as shown in FIG. 5G. Here, the menu has dynamically adapted to include the ‘Add recipient’ option as the default option. This allows the user to insert one or more further media items or files, or to select one of the other options available.

Since the ‘Add recipient’ option is the default option, the dynamic adaptation of the menu allows the most likely action to be performed with a small number of user inputs. However, accessing the menu through the left soft key 17 requires two user inputs between the complete input 67 and the entering of a recipient address or the selection of a recipient from the phonebook application 56 or a list of commonly and/or recently contacted recipients. The number of user inputs can be reduced to one if the scribbler application 45 is arranged such that the depression of one of the alphanumeric keys 14 of the FIG. 1 mobile phone 10 results in the selection of the ‘Add recipient’ option and the entering of the first character of the recipients address, for example email address or telephone number. The entry of a recipient address or selection of a recipient is indicated at 69 in FIG. 4.

Once a recipient address has been highlighted, although prior to selection, or once the address has begun to be entered by the user, the scribbler application 45 can select one of the messaging applications as the default option for carrying the message.

The default option for carrying the message can be determined on any suitable basis.

The mobile phone 30 may be provided with default rules for determining the default option. These rules m ay be modifiable by the user according to his or her preferences.

If the address entered by the user is an email address, then the email application 47 is the default application for sending the message. If the user selects a recipient from the phonebook application 56 and that recipient has only an email address associated with them, then the email application 47 is the default carrier for the message.

The scribbler application 45 is arranged to determine whether or not it will be possible to send the message by SMS. It will not be possible if, for example, any files or media items were included in the message, or if the length of the message is such that it cannot be carried by a relatively small number of concatenated messages. The scribbler application 45 is arranged also to determine whether the message can be sent by MMS. This would not be possible if, for example, two different images were included in the message, since the MMS standard does not allow for multiple images to be included in a single message unless they are part of a single video media item: A messaging option which is not currently available is not selected by the scribbler application 45 as the default option.

The scribbler application 45 is arranged to take account of the cost of sending the message via the various available messaging options, and to take account of the costs when determining what is the default messaging service. The decision may take account as well of the available radio networks. For instance, it is not usually possible to send an email through a GSM network, although it is possible to send an email through a GPRS or 3G network. Where 3G and GPRS networks were not available, the scribbler application 45 would normally select the MMS application 50, since this can utilise the GSM network.

The user may enter preferences specific to certain recipients stored in their phonebook 56. For instance, the user may specify that certain recipients prefer email messages, and specify other recipients who prefer MMS messages.

Whatever technique is used, the default messaging application selected by the scribbler application 45 is provided to the user as selectable through the right soft key 18 or through selection of a ‘Send’ option in the overlaid ‘Options’ submenu. The former is illustrated by the screen shot of FIG. 5G, and the latter is illustrated by the screen shot of FIG. 5H. The screen shot of FIG. 5H also shows that the message may be sent through other than the default messaging option by pressing the right directional key 15, which causes the scribbler application 45 to overlay a further submenu illustrating other messaging options. In the example shown in FIG. 5H, the SMS option is greyed out since the message includes media items which are unable to be transmitted by SMS.

FIG. 5H also illustrates that further recipients can be added, and also that further media items and files can inserted into the message. The overlaid menu shown in FIG. 5H also provides ‘Delete’ and ‘Help’ options. Since the sending of the message is the most likely option to be selected, the scribbler application 45 presents this option as the default option. Accordingly, the user need only make one user input for the message to be sent by the default messaging option. The mobile phone 30 determines at step 70 whether the user has indicated that the default messaging method is required then proceeds either to send the message by the default messaging service at step 71 directly, or proceeds to display the available step messaging services at step 72 and to send the message at step 71 following selection of one of them by way of a selection input 73, as appropriate.

The step 71 of sending a message involves the scribbler application 45 incorporating the message contents into a message using the appropriate one of the email application 47, the instant messaging application 48, the SMS application 49 and the MMS application 50, and controlling that messaging application to send a message.

If the message is to be sent as an SMS using the SMS application 49, the mobile phone 30 prepares an SMS which includes the drawing represented as a bit map, as is currently supported by the SMS standards. This is a relatively straightforward procedure which involves using the process originally designed for allowing icons, graphics and animations to be sent to SMS-enabled mobile telephones. This ensures that the drawing can be reproduced correctly on any receiving mobile terminal which is provided with an SMS application arranged to handle SMS messages which conform to the SMS standards. Thus, the recipients will not need any special hardware or software in order to display the drawing entered by the user on the mobile phone 30.

Where the message is to be sent as a email, the scribbler application 45 and the email application 47 ensure that the message is one which conforms to email standards. In particular, the drawing may be represented as a embedded or attached bit-map file (*.bmp) or in any other suitable form which can be rendered correctly by an email application operable to handle messages sent by email standards.

Similarly, if the message is to be sent as a MMS, the scribbler application 45 and the MMS application 50 ensure that the message conforms to the MMS standards.

Also, in the event that the message is to be sent as an instant message, the scribbler application 45 and the instant messaging application 48 ensure that the message conforms to the instant messaging standards. The result of this is that whatever messaging option is used, no special software or hardware, other than a messaging application are able to handle correctly messages according to the relevant standard, needs to be provided at the recipients terminal.

As well as enabling drawings to be sent by mobile devices, the scribbler application 45 allows simple text communication where it would be inconvenient to use Roman characters. For example, if it is relatively easy for a user to enter Chinese, Thai, Korean, Mongolian, etc. characters as freehand inputs using the freehand input hardware 42 and for these to be sent as images. Thus, text communication between mobile terminals other than in an Roman alphabet and without the use of complicated key translations or the use of special software or hardware at the receiving device is allowed. Prior to this invention, it has been a relatively complicated process to send non-Roman character text between mobile devices, or lo else it has involved requiring special software at the recipient device. The invention is particularly convenient therefore where SMS or MMS is the carrier for the message, since SMS or MMS applications are relatively commonly found in mobile phones.

What is claimed is:

1. A handheld portable communications terminal comprising:
a freehand input device; and
at least one messaging application; the messaging application being operable to allow a user to input a drawing using the freehand input device, to produce drawing data in a standard or commonly-used format representative of the drawing, and to send a message in a standard or commonly-used format incorporating the drawing data, thereby allowing the drawing to be reproduced by a receiving terminal equipped with a standard or common messaging application.

2. A terminal as claimed in claim 1, in which the freehand input device includes a touch screen.

3. A terminal as claimed in claim 1, in which the freehand input device includes an external input device coupled to the terminal.

4. A terminal as claimed in claim 1, in which the terminal includes first and second messaging applications, the first messaging application being operable to allow a user to input the drawing, and the second messaging application being operable to send the message.

5. A terminal as claimed in claim 4, in which the first messaging application is operable to select the second messaging application from a plurality of messaging applications included with the terminal.

6. A terminal as claimed in claim 5, in which the first messaging application is operable to select the second messaging application based at least in part on an address type of a recipient address to which the message is addressed.

7. A terminal as claimed in claim 5, in which the first messaging application is operable to select the second messaging application based at least in part on a content of the message.

8. A terminal as claimed in claim 5, in which the first messaging application is operable to select the second messaging application based at least in part on an expected cost of sending the message.

9. A terminal as claimed in claim 5, in which the first messaging application is operable to select the second messaging application based at least in part on radio networks which are available to the terminal.

10. A terminal as claimed in claim 5, in which the first messaging application is operable to select the second messaging application based at least on at least one preexisting user preference.

11. A terminal as claimed in claim 5, in which the second messaging application selected by the first messaging application is provided to a user as a selectable default send option.

12. A terminal as claimed in claim 4, wherein the second messaging application is selected from the group:
a) SMS application,
b) MMS application,
c) instant message application, and
d) email application.

13. A method of operating a handheld portable communications terminal, the terminal comprising: a freehand input device, and at least one messaging application, the method comprising:
allowing a user to input a drawing using the freehand input device,
producing drawing data, representative of the drawing, in a standard or commonly-used format, and
sending a message in a standard or commonly-used format incorporating the drawing data,
thereby allowing the drawing to be reproduced by a receiving terminal equipped with a standard or common messaging application.

14. A method as claimed in claim 13, in which the terminal includes first and second messaging applications, the first messaging application being operable to allow a user to input the drawing, and the second messaging application being operable to send the message.

15. A method as claimed in claim 14, the first messaging application selecting the second messaging application from a plurality of messaging applications included with the terminal.

16. A terminal as claimed in claim 15, the first messaging application selecting the second messaging application based at least in part on an address type of a recipient address to which the message is addressed.

17. A terminal as claimed in claim 15, the first messaging application selecting the second messaging application based at least in part on a content of the message.

18. A method as claimed in claim 15, the first messaging application selecting the second messaging application based at least in part on an expected cost of sending the message.

19. A method as claimed in claim 15, the first messaging application selecting the second messaging application based at least in part on radio networks which are available to the terminal.

20. A method as claimed in claim 15, the first messaging application selecting the second messaging application based at least on at least one pre-existing user preference.

21. A method as claimed in claim 15, in which the second messaging application selected by the first messaging application is provided to a user as a selectable default send option.

22. A method as claimed in claim 15, wherein the second messaging application is selected from the group:
a) SMS application,
b) MMS application,
c) instant message application, and
d) email application.

23. Machine-readable instructions which when executed by computer apparatus control it to perform the method of claim 13.

24. Computer-readable media having stored thereon machine readable instructions which when executed by computer apparatus control it to perform the method of claim 13.

25. A mobile terminal operable to allow a user to enter a drawing for sending through a messaging application, the messaging application being:
responsive to the opening of the messaging application to provide for the immediate entry of a drawing using a freehand input device;
responsive to an input indicating the completion of content entry to provide means to allow a recipient address to be entered or selected; and
responsive to the entry or selection of a recipient address to allow the message to be sent through a single user input.

26. A terminal as claimed in claim 25, in which the terminal is arranged to display a dynamic menu in response to a user input.

27. A terminal as claimed in claim 26, in which the dynamic menu includes as a default option an option which relates to an action in a pre-determined sequence which immediately follows an action which has most recently been completed by a user.

28. A terminal as claimed in claim 25, in which the freehand input device includes a touch screen.

29. A terminal as claimed in claim 25, in which the freehand input device includes an external input device coupled to the terminal.

30. A method of operating a mobile terminal to allow a user to enter a drawing for sending through a messaging application forming part of the terminal, the method comprising:
in response to the opening of the messaging application, to providing for the immediate entry of a drawing using a freehand input device;
in response to an input indicating the completion of content entry, providing means to allow a recipient address to be entered or selected; and
in response to the entry or selection of a recipient address, allowing the message to be sent through a single user input.

31. A method as claimed in claim 30, comprising displaying a dynamic menu in response to a user input.

32. A method as claimed in claim 31, comprising including in the dynamic menu as a default option an option which relates to an action in a pre-determined sequence which immediately follows an action which has most recently been completed by a user.

33. Machine-readable instructions which when executed by computer apparatus control it to perform the method of claim 30.

34. Computer-readable media having stored thereon machine readable instructions which when executed by computer apparatus control it to perform the method of claim 30.
